(19) United States
(12) Patent Application Publication
(10) Pub. No.: US 2005/0089217 A1
(43) Pub. Date: Apr. 28, 2005

(54) Data creation method data creation apparatus and 3-dimensional model

(76) Inventors: Tatsuyuki Nakagawa, Moriguchi-Shi (JP); Hitoshi Kihara, Moriguchi-Shi (JP); Naoya Ishikawa, Moriguchi- Shi (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/492,203

(22) PCT Filed: Oct. 21, 2002
(86) PCT No.: PCT/JP02/10895

(30) Foreign Application Priority Data
Oct. 22, 2001 (JP) 2001-323604

(51) Int. Cl. G06K 9/00

(52) U.S. Cl. 382/162; 345/419

(57) ABSTRACT

From texture image data divided by a data dividing unit (1), image data of characteristic portion is extracted by a characteristic portion extracting unit (2). After this, the image data of the characteristic portion is converted into a Gray scale by a Gray scale converting unit (3) and subjected to image processing by a characteristic portion processing unit (4). According to the luminance value of the image data of the characteristic portion which has been subjected to the image processing, a high-low converting unit (5) sets a coordinate position shifting amount. According to this shifting amount set, a data amount of the 3-dimensional shape data given from the data dividing unit (1) is converted by a 3-dimensional shape data converting unit (6). From the 3-dimensional shape data converted, shape data representing the 3-dimensional coordinate position is generated by a shape data extracting unit (7).

### TECHNICAL FIELD

The present invention relates to a method and an apparatus for creating shape data representing the shape of a three-dimensional object. In particular, the present invention relates to a method and an apparatus for creating shape data for reproducing shades of lightness and darkness in a characteristic portion of an object, such as a facial expression of a human.

### BACKGROUND ART

A three-dimensional model can be produced on the basis of three-dimensional shape data. This is achieved, for example, by cutting a cylindrical material into a desired shape, or by pressing a resin or other material into a desired shape by use of a mold, according to three-dimensional shape data. There have conventionally been proposed various methods for that purpose, and some of them employ three-dimensional data obtained by evaluating the elevations and depressions on the surface of a sample by analyzing images obtained by photographing the sample from different directions.

However, when a three-dimensional model is produced solely on the basis of three-dimensional shape data of a sample in this way, the produced three-dimensional model only reflects the elevations and depressions on the exterior of the sample. Thus, when the three-dimensional model is produced from a monochrome resin or other material, it is impossible to distinctly reproduce such portions of the sample as are characterized by shades of color. Thus, for example, when the sample is, for example, the head part, including the face, of a human, and a three-dimensional model is produced on the basis of three-dimensional shape data obtained from that sample, since the three-dimensional shape data does not finely reflect the characteristic porticos of the human face, such as the eyebrows, eyes, nose, mouth, wrinkles, and hollows, it is difficult to reproduce the details of the expression and features on the face.

### DISCLOSURE OF THE INVENTION

An object of the present invention is to provide a method and an apparatus for creating data of a three-dimensional object in such a way as to permit reproduction of such portions of the object as are characterized by shades of color. Another object of the present invention is to provide a three-dimensional model produced on the basis of data created by such a data creation method or apparatus.

To achieve the above objects, according to the present invention, a data creation method for creating three-dimensional shape data includes the steps of: acquiring first shape data representing the coordinate positions of the points describing the exterior of a three-dimensional object and image data representing the colors and brightness at the individual positions represented by the first shape data; extracting, from the image data, the image data of a characteristic portion of the three-dimensional object that characterizes the three-dimensional object, and generating, as the three-dimensional shape data, second shape data by converting, based on the brightness values in the characteristic portion, the data values of that portion of the first shape data which corresponds to the characteristic portion so as to change the level differences among the individual points in the characteristic portion as measured in the direction normal thereto.

### BRIEF DESCRIPTION OF DRAWINGS

FIG. 1 is a block diagram showing the internal configuration of a data creation apparatus embodying the invention.

FIGS. 2A to 2C are diagrams showing the relationship between three-dimensional shape data and texture image data.

FIGS. 3A to 3E are diagrams showing how texture image data is processed.

FIG. 4 is a diagram showing the relationship between brightness values and shift distances.

FIG. 5 is a diagram showing the operation of the three-dimensional shape data converting unit.

FIGS. 6A and 6B are diagrams showing, respectively, the appearance of a three-dimensional model according to its three-dimensional shape data before being processed by the data creation apparatus and the appearance of the three-dimensional model according to its shape data after being processed by the data creation apparatus.

### BEST MODE FOR CARRYING OUT THE INVENTION

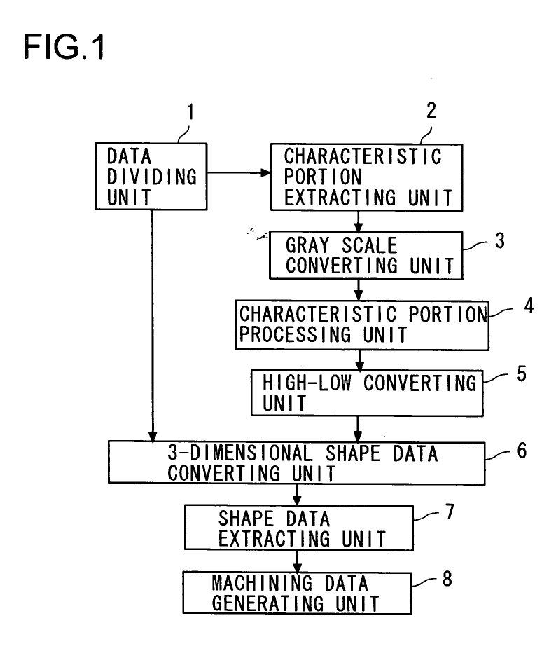

Hereinafter, an embodiment of the present invention will be described with reference to the drawings. FIG. 1 is a block diagram showing the internal configuration of the data creation apparatus embodying the invention. In this embodiment, a human face will be dealt with as a sample of a three-dimensional model. It should be understood, however, that any other object may be used as the sample.

The data creation apparatus shown in FIG. 1 is composed of: a data dividing unit 1 that divide between three-dimensional shape data and texture image data, of which a description will be given later; a characteristic portion extracting unit 2 that extracts the image data of that portion of the texture image obtained from the texture image data outputted from the data dividing unit 1 which corresponds to a characteristic portion, of which a description will be given later; a gray scale converting unit 3 that converts the image data obtained from the characteristic portion extracting unit 2 from RGB (red, green, and blue) data into data consisting of gray scale levels ranging from black to white; a characteristic portion processing unit 4 that subjects relevant parts of the image data fed from the gray scale converting unit 3 to different kinds of image processing appropriate therefor; a high-low converting unit 5 that calculates the shift distance over which shape data included in the three-dimensional shape data is to be shifted; a three-dimensional shape data converting unit 6 that converts the three-dimensional shape data fed from the data dividing unit 1 according to the shift distance fed from the high-low converting unit 5; a shape data extracting unit 7 that extracts only shape data from the three-dimensional shape data converted by the three-dimensional shape data converting unit 6; and a machining data generating unit 8 that generates machining data on the basis of which a three-dimensional model is to be produced.

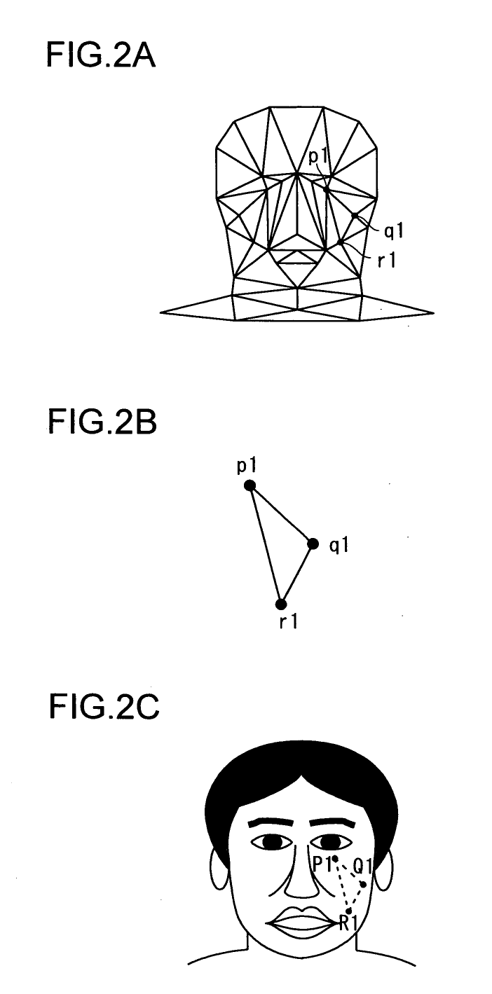

Now, with reference to the drawings, a description will be given of three-dimensional shape data and texture image data that is fed to the data creation apparatus configured as described above. The three-dimensional shape data and texture image data used here is data created by the use of a method for producing a three-dimensional model as proposed, for example, Japanese Patent Application Laid-Open No. H10-124704. As shown in FIGS. 2A to 2C, the three-dimensional shape data includes: coordinate position data consisting of shape data, which represents three-dimensional absolute coordinate positions describing the elevations and depressions on the surface of the sample, and image position specifying data, which indicates the positions on a texture image corresponding to those absolute coordinate positions; and triangular patch data, which indicates three points that define each of the triangular patches that together form a polygon and which also indicates the file name of the corresponding texture image data.

Here, the coordinate position data is expressed as (x, y, z, a, b), where (x, y, z) represents the three dimensional absolute coordinate position and (a, b) represents the coordinate position on the texture image that correspond to the position (x, y, z,). On the other hand, the triangular patch data is expressed as (p-q-r, f), where p, q, and r represent the vertices of the triangular patch represented by the coordinate position data and f represents the file name of the texture image data that is pasted on that triangular patch. Here, the texture image data is image data obtained in the form of a JPEG (Joint Photographic Coding Experts Group) or bit-map file containing RGB data as a result of developing continuous images.

Specifically, suppose that the absolute coordinate positions included in the coordinate position data describe a polygon as shown in FIG. 2A, and that the texture image data contained in the file f1 describes a texture image as shown in FIG. 2C. Then, the image in the area surrounded by points P1, Q1, and R1 in FIG. 2C is pasted on a triangular patch as shown in FIG. 2B that is surrounded by points p1, q1, and r1 shown in FIG. 2A.

Here, if it is assumed that p1, q1, and r1 are (x1, y1, z1), (x2, y2, z2), and (x3, y3, z3), respectively, and that P1, Q1, and R1 are (a1, b1), (a2, b2), and (a3, b3), respectively, then the coordinate position data corresponding to points P1, Q1, and R1 are (x1, y1, z1, a1, b1), (x2, y2, z2, a2, b2), and (x3, y3, z3, a3, b3), respectively. Thus, the triangular patch shown in FIG. 2B yields triangular patch data (p1-q1-r1, f1).

When three-dimensional shape data, which includes coordinate position data and triangular patch data, and texture image data as described above is fed to the data creation apparatus shown in FIG. 1, first, in the data dividing unit 1, the three-dimensional shape data is separated from the texture image data. Then, the three-dimensional shape data is fed to the three-dimensional shape data converting unit 6, and the texture image data is fed to the characteristic portion extracting unit 2.

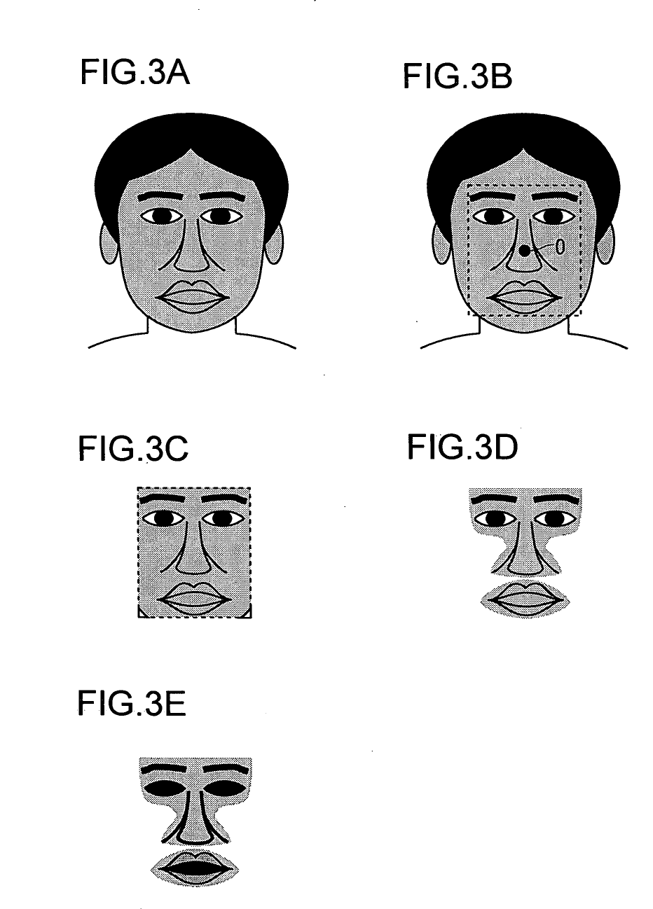

In the characteristic portion extracting unit 2, first, from the texture image data fed thereto, the image data within a characteristic region including characteristic portions is extracted. Here, characteristic portions denote those portions of the texture image sample which most distinctively characterize it, and a characteristic region denotes a region set relative to a central portion of such characteristic portions. Specifically, in a case where, as in this embodiment, the sample is a human face, characteristic portions correspond to the eyes, nose, eyebrows, mouth, hollows, and wrinkles, and a characteristic region is set relative to the nose as its center so as to include those characteristic portions, namely the eyes, nose, eyebrows, mouth, hollows, and wrinkles. Accordingly, in a case where a texture image as shown in FIG. 3A is described, a characteristic region is set around the nose as its center 0 as shown in FIG. 3B, and thus the characteristic region is extracted as shown in FIG. 3C.

When the image data within the characteristic region is extracted in this way, then, from the image data within the characteristic region, such regions in which the RGB data values are respectively within predetermined ranges of data values are excluded so that only the image data of the characteristic portions is extracted. Specifically, in a case where, as in this embodiment, the sample is a human face, skin-colored regions where R=150 to 200, G=130 to 180, and B=90 to 140 (all these values are on a gray scale ranging from 0 to 255 for each chrominance signal) are not regarded as characteristic portions and thus are excluded. Thus, as a result of skin-colored regions, which fulfill the above RGB gray scale levels, being excluded from the characteristic region shown in FIG. 3C, the characteristic portions are extracted as shown in FIG. 3D.

When the image data of the characteristic portions is extracted in this way, then the extracted image data is fed to the gray scale converting unit 3, where the image data of the characteristic portions is converted from RGB data into gray data consisting of levels ranging from black to white. Thus, the image data handled by the later stages, namely the characteristic portion processing unit 4 and the high-low converting unit 5, is all gray data. In this image data given as gray data, the values it contains are brightness values and thus represent how light or dark different parts of the image are. For example, in a case where the image data given as gray data is digital data on a 256-level gray scale, “0” represents the darkest level and “255” represents the lightest level.

When the image data of the characteristic portions converted into gray data in this way is fed to the characteristic portion processing unit 4, the image data is processed by performing different kinds of image processing, such as edge enhancement processing, gradation processing, and brightness correction processing, individually in different regions corresponding to the individual characteristic portions. First, to make clear the features of the characteristic portions as a whole, edge enhancement processing is performed. Thereafter, for such portions where, as a result of edge enhancement processing, the variation of the brightness values across a border line becomes undesirably great, after edge enhancement processing, gradation processing is performed to smooth out the border lines. Moreover, in such portions as need to be flat as a whole without elevations or depressions, after edge enhancement processing, brightness correction processing is performed to make the brightness values equal.

In the characteristic portion processing unit 4 operating as described above, in a case where, as in this embodiment, the sample is a human face, first, to emphasize the characteristic portions, namely the eyes, nose, eyebrows, mouth, hollows, and wrinkles, edge enhancement processing is performed on the characteristic portions as a whole. This helps, for example, to make the outlines of the eyes clearer and to emphasize the double-lidded eyes. When edge enhancement processing is performed on the eyebrows and mouth, they come to appear differently from what they actually are. To make them appear as natural as possible, next, gradation processing is performed to make gentle the variation of brightness across their border lines. Moreover, to make the brightness values equal within the white and black portions of the eyes, brightness correction processing is performed in the entire region inside the eyes. In this way, the image data of the characteristic portions shown in FIG. 3D is, as a result of different regions thereof being subjected to different kinds of image processing appropriate therefor, converted into the image data of characteristic portions as shown in FIG. 3E.

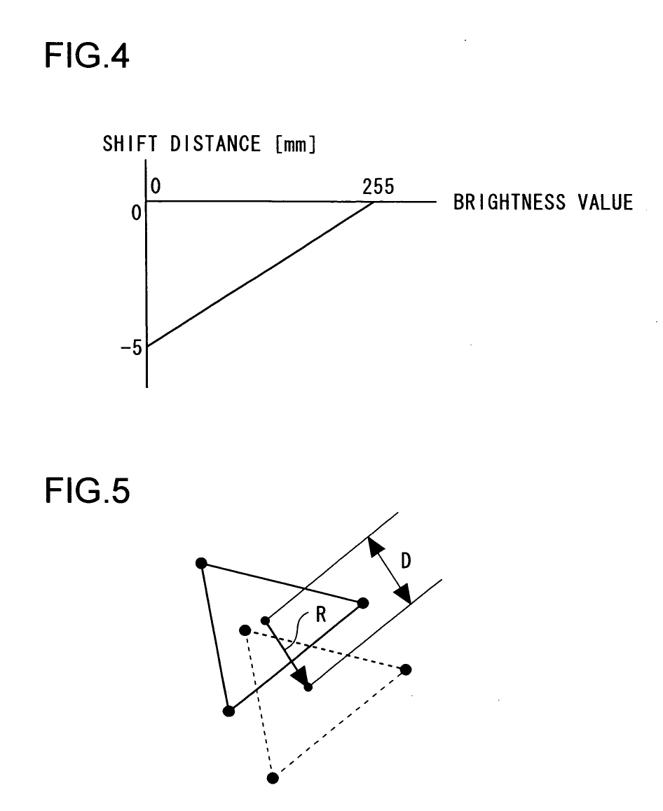

The image data processed by the characteristic portion processing unit 4 in this way is then fed to the high-low converting unit 5, where the brightness values of the image data are converted into shift distances to generate shift data that represents those shift distances. Here, the brightness values are proportional to the shift distances. Accordingly, in a case where the image data is on a 256-level gray scale as described above, the shift data is generated in such a way that a brightness value “0” corresponds to the longest shift distance and a brightness value “255” to the zero shift distance. For example, as shown in FIG. 4, in a case where the shift distance corresponding to a brightness value “0” is 25 mm and the shift distance corresponding to a brightness value “255” is zero, every increment of 1 in the brightness value corresponds to an extra shift distance of about −0.02 mm. Thus, here, the brightness value L and the shift distance s fulfill the relationship s=−0.02×L.

While the shift data for the characteristic portions is generated in this way, the shift distances for all the other portions than the characteristic portions extracted by the characteristic portion extracting unit 2 are made equal to zero. Thus, the shift data for the entire region is generated by combining together the shift distances for the characteristic portions and those for the other portions than the characteristic portions. Here, it is assumed that both the image data (including the texture image data) and the shift data described above include data relating to the coordinate positions on the texture image.

The shift data thus generated by converting the brightness values of the image data into shift distances is fed to the three-dimensional shape data converting unit 6, to which is also fed the three-dimensional shape data from the data dividing unit 1. Then, first, for each of the triangular patches obtained from the triangular patch data included in the three-dimensional shape data, the shift distance for that triangular patch is calculated. Here, the shift distance for each triangular patch is calculated, for example in the case of the triangular patch defined by points p1, q1, and r1 shown in FIG. 2B, by calculating the average value of the shift distances, as calculated by the high-low converting unit 5, of the points within the region enclosed by points P1, Q1, and R1 shown in FIG. 2C which corresponds to that triangular patch.

When the shift distances for the individual triangular patches are calculated in this way, then their normal vectors are calculated as their shift directions. Here, on the basis of the triangular patch data of each triangular patch, the three points that define that triangular patch are recognized, and then, for those three points individually, their absolute coordinate positions are identified on the basis of the coordinate position data. Then, on the basis of the thus identified absolute coordinate positions, a normal vector to be used as the unit vector is calculated. Thus, for example, the normal vector of the triangular patch defined by points p1, q1, and r1 shown in FIG. 2B is expressed, assuming that k=(((y2−y1) (z3−z1)−(y3−y1)(z2−z1))²+((z2−z1)(x3−x1)−(z3−z1)(x2−x1))²+((x2−x1)(y3−y1)−(x3−x1) (y2−y1))²)^{1/2}, as follows:
(((y2−y1) (z3−z1)−(y3−y1)(z2−z1))/k, ((z2−z1)(x3−x1)−(z3−z1)(x2−x1))/k, ((x2−x1)(y3−y1)−(x3−x1)(y2−y1))/k

When the shift distances for and the normal vectors of the individual triangular patches are calculated in this way, then, for each triangular patch, the absolute coordinate positions of the points that define the triangular patch are changed so that the triangular patch is shifted over the calculated shift distance in the direction of its normal vector. Specifically, in the case of the triangular patch defined by points p1, q1, and r1 shown in FIG. 2B, as shown in FIG. 5, the coordinate position data is so changed that the absolute coordinate positions of points p1, q1, and r1 are shifted over a distance D in the direction of the normal vector R. In this way, the coordinate position data is changed, and thereby the three-dimensional shape data is converted.

The thus converted three-dimensional shape data is then fed to the shape data extracting unit 7, where, from the coordinate position data (x, y, z, a, b) included in the three-dimensional shape data, the portion (x, y, z) thereof representing the absolute coordinate positions is extracted as shape data. In this way, on the basis of the shift data obtained from the image data of the characteristic portions of the texture image data, shape data is generated such that the characteristic portions within the texture image are emphasized.

Then, the generated shape data is fed to the machining data generating unit 8, where machining data is generated on the basis of which to produce a three-dimensional model. Here, as the machining data is generated, for example in a case where a three-dimensional model is produced by machine-cutting, data for machine-cutting that defines the path, cutting depth, and other parameters of the end mill for cutting a cylindrical material. This machining data is generated in a way that suits the method by which a three-dimensional model is produced. For example, in a case where a three-dimensional model is produced by light prototyping, data for light prototyping is generated.

The machining data generated by the machining data generating unit 8 is then fed to production equipment for producing the three-dimensional model so that the production equipment automatically operates according to the machining data to produce the three-dimensional model. The thus produced three-dimensional model has the darkness and lightness in the characteristic portions emphasized. That is, the three-dimensional model here is so produced as to have greater level differences in the characteristic portions than in the other portion than the characteristic portions.

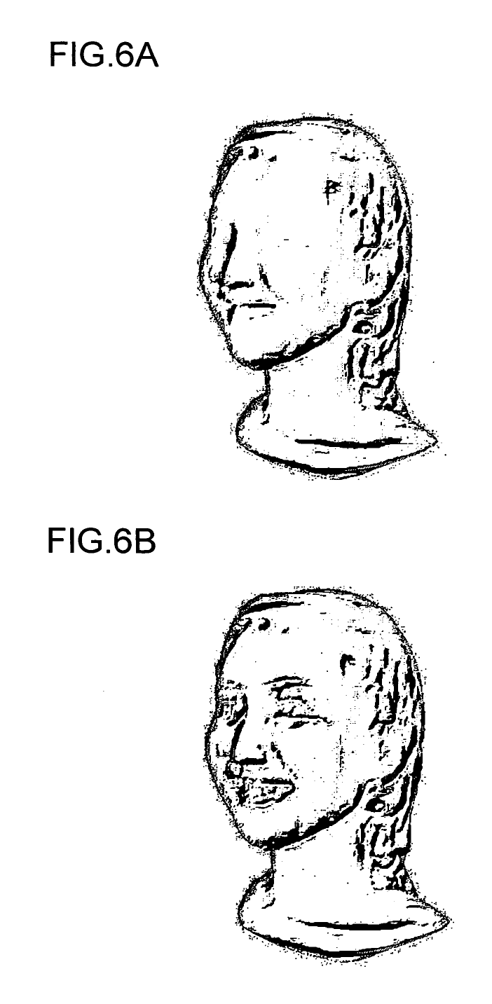

Accordingly, in a case where the sample is a human face, the characteristic portions, namely the eyes, nose, eyebrows, mouth, hollows, and wrinkles, are reproduced with increased level differences, and thus a three-dimensional model is produced that has the darkness and lightness emphasized in the characteristic portions of the texture image, namely the eyes, nose, eyebrows, mouth, hollows, and wrinkles. Specifically, when a three-dimensional model as shown in FIG. 6A is produced on the basis of the shape data obtained from the three-dimensional shape data fed to the data creation apparatus, a three dimensional model as shown in FIG. 6B is produced on the basis of the shape data outputted from the data creation apparatus.

The example described above deals with a case where, on the basis of the machining data created by the data creation apparatus, a three-dimensional model is produced by machine-cutting using an end mill or the like. It is, however, possible to produce a three-dimensional model by any other method than specifically described above, for example by light prototyping.

In this embodiment, the characteristic potion extracting unit extracts the image data of the characteristic portions from the characteristic region by excluding skin-shaped regions. It is, however, also possible to specify predetermined ranges of RGB gradation levels within which the image data of the characteristic portions are supposed to be and extract as the image data of the characteristic portions those of which the RGB data is within those ranges.

In this embodiment, the high-low converting unit calculates shift distances by using a continuous, linear equation as shown in FIG. 4 that represents their relationship with brightness values. It is, however, also possible to calculate them by using a non-linear, for example quadratic or cubic, equation, or by using an equation that represents a discontinuous but monotonically increasing or decreasing relationship. It is possible even to permit operation from outside so that the equation used by the high-low converting unit to calculate shift distances is selected from among a plurality of such equations.

In this embodiment, the characteristic portions are emphasized by calculating, for each triangular patch defined by three points, the shift distance that suits the brightness values within that triangular patch and then translationally shifting the triangular patch over the thus calculated distance in its normal direction. It is, however, also possible to emphasize the characteristic portions by calculating, for each triangular patch defined by three points, the correction angle that suits the brightness values within that triangular patch and then changing the coordinate position of at least one of the three vertices of the triangular patch so as to correct for the thus calculated angle.

### Industrial Applicability

According to the present invention, the data values of three-dimensional shape data are converted on the basis of shades of lightness and darkness in image data, and this makes it possible to obtain three-dimensional shape data that reflects the shades of color on the surface of a sample of a three-dimensional model. By producing a three-dimensional model on the basis of such three-dimensional shape data, it is possible to reproduce with emphasis the features on the sample of the three-dimensional model. Specifically, in a case where a human face is used as the sample, it is possible to emphasize its features, such as the expression of the person, on the monochrome three-dimensional model.

1. (canceled)

2. A data creation method for creating three-dimensional shape data, comprising the steps of:
acquiring
first shape data representing coordinate positions of points describing an exterior of a three-dimensional object and
image data representing colors and brightness at the individual positions represented by the first shape data;
extracting, from the image data, image data of a characteristic portion of the three-dimensional object that characterizes the three-dimensional object, and
generating, as the three-dimensional shape data, second shape data by converting, based on brightness values in the characteristic portion, data values of that portion of the first shape data which corresponds to the characteristic portion so as to change level differences among the individual points in the characteristic portion as measured in a direction normal thereto.

3. A data creation method as claimed in claim 2, wherein the characteristic portion is extracted by
first extracting, from the image data, data of a region in which the characteristic portion is located, and
then excluding, from the data of the so extracted region, data of a region in which a chrominance signal has a signal level within a predetermined range.

4. A data creation method as claimed in claim 3,
wherein edge enhancement processing is performed on the characteristic portion to obtain a clear outline.

5. A data creation method as claimed in claim 4,
wherein gradation processing is performed on part of the characteristic portion so that gentle conversion is performed across a boundary line.

6. A data creation method as claimed in claim 5,
wherein the second shape data is generated by converting the data values of the first shape data in such a way that, the closer are the brightness values of the image data to a predetermined range of brightness values, the larger are the level differences in corresponding portions of the shape described by the first shape data.

7. A data creation method as claimed in claim 6,
wherein
the first shape data is polygon data representing
coordinate positions of a plurality of points and
a plurality of polygons each surrounded by a predetermined number of points among those points, and
the coordinate positions of the points as changed by shifting the polygons respectively in directions normal thereto are used as the second shape data.

8. A data creation method as claimed in claim 7,
wherein
the first shape data is composed of
position data representing the coordinate positions of the individual points describing the three-dimensional object and
triangular patch data representing triangular patches each surrounded by three among those points,
distances over which the individual triangular patches are to be shifted are determined based on average values each calculated from a plurality of brightness values obtained from the image data within each triangular patch as obtained from the triangular patch data, and
the coordinate positions of the points as changed by shifting the triangular patches respectively in directions normal thereto over the so determined shift distances are used as the second shape data.

9. A data creation method as claimed in claim 4,
wherein processing for making brightness values equal in a region within a predetermined boundary line is performed on part of the characteristic portion.

10. A data creation method as claimed in claim 9,
wherein the second shape data is generated by converting the data values of the first shape data in such a way that, the closer are the brightness values of the image data to a predetermined range of brightness values, the larger are the level differences in corresponding portions of the shape described by the first shape data.

11. A data creation method as claimed in claim 10,
wherein
the first shape data is polygon data representing
coordinate positions of a plurality of points and
a plurality of polygons each surrounded by a predetermined number of points among those points, and
the coordinate positions of the points as changed by shifting the polygons respectively in directions normal thereto are used as the second shape data.

12. A data creation method as claimed in claim 11,
wherein
the first shape data is composed of
position data representing the coordinate positions of the individual points describing the three-dimensional object and
triangular patch data representing triangular patches each surrounded by three among those points,
distances over which the individual triangular patches are to be shifted are determined based on average values each calculated from a plurality of brightness values obtained from the image data within each triangular patch as obtained from the triangular patch data, and
the coordinate positions of the points as changed by shifting the triangular patches respectively in directions normal thereto over the so determined shift distances are used as the second shape data.

13. A data creation method as claimed in claim 4,
wherein the second shape data is generated by converting the data values of the first shape data in such a way that, the closer are the brightness values of the image data to a predetermined range of brightness values, the larger are the level differences in corresponding portions of the shape described by the first shape data.

14. A data creation method as claimed in claim 13,
wherein
the first shape data is polygon data representing
coordinate positions of a plurality of points and
a plurality of polygons each surrounded by a predetermined number of points among those points, and
the coordinate positions of the points as changed by shifting the polygons respectively in directions normal thereto are used as the second shape data.

15. A data creation method as claimed in claim 14,
wherein
the first shape data is composed of
position data representing the coordinate positions of the individual points describing the three-dimensional object and
triangular patch data representing triangular patches each surrounded by three among those points,
distances over which the individual triangular patches are to be shifted are determined based on average values each calculated from a plurality of brightness values obtained from the image data within each triangular patch as obtained from the triangular patch data, and
the coordinate positions of the points as changed by shifting the triangular patches respectively in directions normal thereto over the so determined shift distances are used as the second shape data.

16. A data creation method as claimed in claim 3,
wherein gradation processing is performed on part of the characteristic portion so that gentle conversion is performed across a boundary line.

17. A data creation method as claimed in claim 16,
wherein the second shape data is generated by converting the data values of the first shape data in such a way that, the closer are the brightness values of the image data to a predetermined range of brightness values, the larger are the level differences in corresponding portions of the shape described by the first shape data.

18. A data creation method as claimed in claim 17,
wherein
the first shape data is polygon data representing
coordinate positions of a plurality of points and
a plurality of polygons each surrounded by a predetermined number of points among those points, and
the coordinate positions of the points as changed by shifting the polygons respectively in directions normal thereto are used as the second shape data.

19. A data creation method as claimed in claim 18,
wherein
the first shape data is composed of
position data representing the coordinate positions of the individual points describing the three-dimensional object and
triangular patch data representing triangular patches each surrounded by three among those points,
distances over which the individual triangular patches are to be shifted are determined based on average values each calculated from a plurality of brightness values obtained from the image data within each triangular patch as obtained from the triangular patch data, and
the coordinate positions of the points as changed by shifting the triangular patches respectively in directions normal thereto over the so determined shift distances are used as the second shape data.

20. A data creation method as claimed in claim 3,
wherein processing for making brightness values equal in a region within a predetermined boundary line is performed on part of the characteristic portion.

21. A data creation method as claimed in claim 20,
wherein the second shape data is generated by converting the data values of the first shape data in such a way that, the closer are the brightness values of the image data to a predetermined range of brightness values, the larger are the level differences in corresponding portions of the shape described by the first shape data.

22. A data creation method as claimed in claim 21,
wherein
the first shape data is polygon data representing
coordinate positions of a plurality of points and
a plurality of polygons each surrounded by a predetermined number of points among those points, and
the coordinate positions of the points as changed by shifting the polygons respectively in directions normal thereto are used as the second shape data.

23. A data creation method as claimed in claim 22,
wherein
the first shape data is composed of
position data representing the coordinate positions of the individual points describing the three-dimensional object and
triangular patch data representing triangular patches each surrounded by three among those points,
distances over which the individual triangular patches are to be shifted are determined based on average values each calculated from a plurality of brightness values obtained from the image data within each triangular patch as obtained from the triangular patch data, and
the coordinate positions of the points as changed by shifting the triangular patches respectively in directions normal thereto over the so determined shift distances are used as the second shape data.

24. A data creation method for creating three-dimensional shape data, comprising the steps of:
acquiring
first shape data representing coordinate positions of points describing an exterior of a three-dimensional object and
image data representing colors and brightness at the individual positions represented by the first shape data;
extracting, from the image data, image data of a characteristic portion of the three-dimensional object that characterizes the three-dimensional object, and
generating, as the three-dimensional shape data, second shape data by converting, based on brightness values in the characteristic portion, data values of that portion of the first shape data which corresponds to the characteristic portion so as to change level differences in the characteristic portion, wherein the second shape data is generated by converting the data values of the first shape data so as to chance the coordinate positions of the points in such a way that, the closer are the brightness values of the image data to a predetermined range of brightness values, the larger are the level differences in corresponding portions of the shape described by the first shape data.

25. A data creation method as claimed in claim 24,
wherein
the first shape data is polygon data representing
coordinate positions of a plurality of points and
a plurality of polygons each surrounded by a predetermined number of points among those points, and
the coordinate positions of the points as changed by shifting the polygons respectively in directions normal thereto are used as the second shape data.

26. A data creation method as claimed in claim 25,
wherein
the first shape data is composed of
wherein
the first shape data is composed of
position data representing the coordinate positions of the individual points describing the three-dimensional object and
triangular patch data representing triangular patches each surrounded by three among those points,
distances over which the individual triangular patches are to be shifted are determined based on average values each calculated from a plurality of brightness values obtained from the image data within each triangular patch as obtained from the triangular patch data, and
the coordinate positions of the points as changed by shifting the triangular patches respectively in directions normal thereto over the so determined shift distances are used as the second shape data.

27. A data creation method as claimed in claim 2,
wherein edge enhancement processing is performed on the characteristic portion to obtain a clear outline.

28. A data creation method as claimed in claim 27,
wherein gradation processing is performed on part of the characteristic portion so that gentle conversion is performed across a boundary line.

29. A data creation method as claimed in claim 28,
wherein the second shape data is generated by converting the data values of the first shape data in such a way that, the closer are the brightness values of the image data to a predetermined range of brightness values, the larger are the level differences in corresponding portions of the shape described by the first shape data.

30. A data creation method as claimed in claim 29,
wherein
the first shape data is polygon data representing
coordinate positions of a plurality of points and
a plurality of polygons each surrounded by a predetermined number of points among those points, and
the coordinate positions of the points as changed by shifting the polygons respectively in directions normal thereto are used as the second shape data.

31. A data creation method as claimed in claim 30,
wherein
the first shape data is composed of
position data representing the coordinate positions of the individual points describing the three-dimensional object and
triangular patch data representing triangular patches each surrounded by three among those points,
distances over which the individual triangular patches are to be shifted are determined based on average values each calculated from a plurality of brightness values obtained from the image data within each triangular patch as obtained from the triangular patch data, and
the coordinate positions of the points as changed by shifting the triangular patches respectively in directions normal thereto over the so determined shift distances are used as the second shape data.

32. A data creation method as claimed in claim 27,
wherein processing for making brightness values equal in a region within a predetermined boundary line is performed on part of the characteristic portion.

33. A data creation method as claimed in claim 32,
wherein the second shape data is generated by converting the data values of the first shape data in such a way that, the closer are the brightness values of the image data to a predetermined range of brightness values, the larger are the level differences in corresponding portions of the shape described by the first shape data.

34. A data creation method as claimed in claim 33,
wherein
the first shape data is polygon data representing
coordinate positions of a plurality of points and
a plurality of polygons each surrounded by a predetermined number of points among those points, and
the coordinate positions of the points as changed by shifting the polygons respectively in directions normal thereto are used as the second shape data.

35. A data creation method as claimed in claim 34,
wherein
the first shape data is composed of
position data representing the coordinate positions of the individual points describing the three-dimensional object and
triangular patch data representing triangular patches each surrounded by three among those points,
distances over which the individual triangular patches are to be shifted are determined based on average values each calculated from a plurality of brightness values obtained from the image data within each triangular patch as obtained from the triangular patch data, and
the coordinate positions of the points as changed by shifting the triangular patches respectively in directions normal thereto over the so determined shift distances are used as the second shape data.

36. A data creation method as claimed in claim 27,
wherein the second shape data is generated by converting the data values of the first shape data in such a way that, the closer are the brightness values of the image data to a predetermined range of brightness values, the larger are the level differences in corresponding portions of the shape described by the first shape data.

37. A data creation method as claimed in claim 36,
wherein
the first shape data is polygon data representing
coordinate positions of a plurality of points and
a plurality of polygons each surrounded by a predetermined number of points among those points, and
the coordinate positions of the points as changed by shifting the polygons respectively in directions normal thereto are used as the second shape data.

38. A data creation method as claimed in claim 37,
wherein
the first shape data is composed of
position data representing the coordinate positions of the individual points describing the three-dimensional object and
triangular patch data representing triangular patches each surrounded by three among those points,
distances over which the individual triangular patches are to be shifted are determined based on average values each calculated from a plurality of brightness values obtained from the image data within each triangular patch as obtained from the triangular patch data, and
the coordinate positions of the points as changed by shifting the triangular patches respectively in directions normal thereto over the so determined shift distances are used as the second shape data.

39. A data creation method as claimed in claim 2,
wherein gradation processing is performed on part of the characteristic portion so that gentle conversion is performed across a boundary line.

40. A data creation method as claimed in claim 39,
wherein the second shape data is generated by converting the data values of the first shape data in such a way that, the closer are the brightness values of the image data to a predetermined range of brightness values, the larger are the level differences in corresponding portions of the shape described by the first shape data.

41. A data creation method as claimed in claim 40,
wherein
the first shape data is polygon data representing
coordinate positions of a plurality of points and
a plurality of polygons each surrounded by a predetermined number of points among those points, and
the coordinate positions of the points as changed by shifting the polygons respectively in directions normal thereto are used as the second shape data.

42. A data creation method as claimed in claim 41,
wherein
the first shape data is composed of
position data representing the coordinate positions of the individual points describing the three-dimensional object and
triangular patch data representing triangular patches each surrounded by three among those points,
distances over which the individual triangular patches are to be shifted are determined based on average values each calculated from a plurality of brightness values obtained from the image data within each triangular patch as obtained from the triangular patch data, and
the coordinate positions of the points as changed by shifting the triangular patches respectively in directions normal thereto over the so determined shift distances are used as the second shape data.

43. A data creation method as claimed in claim 2,
wherein processing for making brightness values equal in a region within a predetermined boundary line is performed on part of the characteristic portion.

44. A data creation method as claimed in claim 43,
wherein the second shape data is generated by converting the data values of the first shape data in such a way that, the closer are the brightness values of the image data to a predetermined range of brightness values, the larger are the level differences in corresponding portions of the shape described by the first shape data.

45. A data creation method as claimed in claim 44,
wherein
the first shape data is polygon data representing
coordinate positions of a plurality of points and
a plurality of polygons each surrounded by a predetermined number of points among those points, and
the coordinate positions of the points as changed by shifting the polygons respectively in directions normal thereto are used as the second shape data.

46. A data creation method as claimed in claim 45,
wherein
the first shape data is composed of
position data representing the coordinate positions of the individual points describing the three-dimensional object and
triangular patch data representing triangular patches each surrounded by three among those points,
distances over which the individual triangular patches are to be shifted are determined based on average values each calculated from a plurality of brightness values obtained from the image data within each triangular patch as obtained from the triangular patch data, and
the coordinate positions of the points as changed by shifting the triangular patches respectively in directions normal thereto over the so determined shift distances are used as the second shape data.

47. A data creation method for creating three-dimensional shape data, comprising the steps of:
acquiring
first shape data representing coordinate positions of points describing an exterior of a three-dimensional object and
image data representing colors and brightness at the individual positions represented by the first shape data; and
converting, based on the image data, data values of the first shape data so that the coordinate positions of the individual points are changed so as to generate, as the three-dimensional shape data, second shape data,
wherein in the first shape data are formed triangular patches each surrounded by three points, and the first shape data is changed by translationally shifting individual vertices of each of the triangular patches.

48. A data creation method for creating three-dimensional shape data, comprising the steps of:
acquiring
first shape data representing coordinate positions of points describing an exterior of a three-dimensional object and
image data representing colors and brightness at the individual positions represented by the first shape data; and
converting, based on the image data, data values of the first shape data so that the coordinate positions of the individual points are changed so as to generate, as the three-dimensional shape data, second shape data,
wherein in the first shape data are formed triangular patches each surrounded by three points, and angle correction is performed by changing a coordinate position of at least one of three vertices of each of the triangular patches.

49. A data creation apparatus for creating three-dimensional shape data,
wherein the data creation apparatus uses a data creation method as claimed in one of claims 2 to 48 to generate the second shape data.

50. A data creation apparatus for creating three-dimensional shape data, comprising:
a data divider that divides data fed from outside into
first shape data representing coordinate positions of points describing an exterior of a three-dimensional object and
image data representing colors and brightness at the individual positions represented by the first shape data; and
a characteristic portion extractor that extracts image data of a characteristic portion of the three-dimensional object that characterizes the three-dimensional object by
first extracting, from the image data outputted from the data divider, image data of a characteristic region that is centered around a central position of the characteristic portion and that includes the characteristic portion and
then excluding or extracting, from the image data of the so extracted characteristic region, image data located within a region in which a chrominance signal has a signal level within a predetermined range;
a gray scale converter that converts the image data of the characteristic portion extracted by the characteristic portion extractor into image data consisting of gray scale levels ranging from black to white;
a characteristic portion processor that processes the image data of the characteristic portion outputted from the gray scale converter so that different portions of the image data are subjected to predetermined kinds of image processing appropriate therefor;
a high-low converter that calculates, based on brightness values of the image data of the characteristic portion processed by the characteristic portion processor, shift distances over which the coordinate positions of the points represented by the first shape data are to be shifted; and
a shape data converter that converts the first shape data fed from the data divider by changing, according to the shift distances calculated for the individual points by the high-low converter, the coordinate positions of those points so as to generate, as the three-dimensional shape data, second shape data
wherein
the first shape data is polygon data representing
coordinate positions of a plurality of points and
a plurality of polygons each surrounded by a predetermined number of points among those points, and
the coordinate positions of the points as changed by the high-low converter and the shape data converter by shifting the polygons respectively in directions normal thereto are used as the second shape data.

51. A data creation apparatus for creating three-dimensional shape data, comprising:
a data divider that divides data fed from outside into
first shape data representing coordinate positions of points describing an exterior of a three-dimensional object and
image data representing colors and brightness at the individual positions represented by the first shape data; and
a characteristic portion extractor that extracts image data of a characteristic portion of the three-dimensional object that characterizes the three-dimensional object by
first extracting, from the image data outputted from the data divider, image data of a characteristic region that is centered around a central position of the characteristic portion and that includes the characteristic portion and
then excluding or extracting, from the image data of the so extracted characteristic region, image data located within a region in which a chrominance signal has a signal level within a predetermined range;
a gray scale converter that converts the image data of the characteristic portion extracted by the characteristic portion extractor into image data consisting of gray scale levels ranging from black to white;
a characteristic portion processor that processes the image data of the characteristic portion outputted from the gray scale converter so that different portions of the image data are subjected to predetermined kinds of image processing appropriate therefor;
a high-low converter that calculates, based on brightness values of the image data of the characteristic portion processed by the characteristic portion processor, shift distances over which the coordinate positions of the points represented by the first shape data are to be shifted; and
a shape data converter that converts the first shape data fed from the data divider by changing, according to the shift distances calculated for the individual points by the high-low converter, the coordinate positions of those points so as to generate, as the three-dimensional shape data, second shape data
wherein
the first shape data is polygon data representing
coordinate positions of a plurality of points and
a plurality of polygons each surrounded by a predetermined number of points among those points, and
the coordinate positions of the points as changed by the high-low converter and the shape data converter by changing the coordinate positions of at least one of vertices of each of the polygons so as to perform angle correction are used as the second shape data.

52. A data creation apparatus for creating three-dimensional shape data, comprising:
a data divider that divides data fed from outside into
first shape data representing coordinate positions of points describing an exterior of a three-dimensional object and
image data representing colors and brightness at the individual positions represented by the first shape data; and
a characteristic portion extractor that extracts image data of a characteristic portion of the three-dimensional object that characterizes the three-dimensional object by
first extracting, from the image data outputted from the data divider, image data of a characteristic region that is centered around a central position of the characteristic portion and that includes the characteristic portion and
then excluding or extracting, from the image data of the so extracted characteristic region, image data located within a region in which a chrominance signal has a signal level within a predetermined range;
a gray scale converter that converts the image data of the characteristic portion extracted by the characteristic portion extractor into image data consisting of gray scale levels ranging from black to white;
a characteristic portion processor that processes the image data of the characteristic portion outputted from the gray scale converter so that different portions of the image data are subjected to predetermined kinds of image processing appropriate therefor;
a high-low converter that calculates, based on brightness values of the image data of the characteristic portion processed by the characteristic portion processor, shift distances over which the coordinate positions of the points represented by the first shape data are to be shifted; and
a shape data converter that converts the first shape data fed from the data divider by changing, according to the shift distances calculated for the individual points by the high-low converter, the coordinate positions of those points so as to generate, as the three-dimensional shape data, second shape data
wherein
the high-low converter uses, as an equation for calculating the shift distances over which to shift the coordinate positions of the points, one selectable from among a continuous, linear equation of a first degree, a continuous, non-linear equation, and a discontinuous but monotonically increasing or decreasing equation, and
which of the equations to use when the shift distances over which to shift the coordinate positions of the points is actually calculated is specified from outside.

53. A three-dimensional model produced based on the second shape data created by a data creation method as claimed in one of claims 2 to 48.
